(19) United States
(12) Patent Application Publication
(10) Pub. No.: US 2015/0317626 A1
(43) Pub. Date: Nov. 5, 2015

(54) SECURE PROXIMITY EXCHANGE OF PAYMENT INFORMATION BETWEEN MOBILE WALLET AND POINT-OF-SALE

(71) Applicants: Alexander Ran, Palo Alto, CA (US); Eric C. W. Dunn, Mountain View, CA (US)

(72) Inventors: Alexander Ran, Palo Alto, CA (US); Eric C. W. Dunn, Mountain View, CA (US)

(73) Assignee: INTUIT INC., Mountain View, CA (US)

(21) Appl. No.: 14/266,696

(22) Filed: Apr. 30, 2014

(51) Int. Cl. G06Q 20/38; G06Q 20/20

(52) U.S. Cl. CPC G06Q 20/3821; G06Q 20/20; G06Q 20/3829

(57) ABSTRACT

A method for processing payment is disclosed. The method includes obtaining, by a point-of-sale (POS) device from a certification authority, a certificate data item that identifies the POS device for completing a purchase by a consumer, generating a payment request containing the certificate data item, broadcasting the payment request via a wireless signal within a pre-determined range of the POS device for receiving by a mobile device of the consumer, where the mobile device stores payment credential of the consumer, receiving, by the POS device, an encrypted payment credential from the mobile device, where the encrypted payment credential is generated by the mobile device encrypting the payment credential based on the certificate data item, and decrypting the encrypted payment credential based on the certificate data item to retrieve the payment credential for processing the payment.

### BACKGROUND

Point-of-Sale (POS) software and hardware are available that adapt merchants' smart phones and tablet computers into credit card acceptance devices. Mobile wallet solutions are also available that configure consumers' smart phones into payment instruments. Many of these solutions rely on special hardware capabilities, such as near field communication (NFC) or require tight integration between the consumer payment instrument and merchant payment acceptance device.

Bluetooth Low Energy (also known as Bluetooth SMART or BLE) is a standard for proximity wireless communication.

### SUMMARY

In general, in one aspect, the invention relates to a method for processing payment. The method includes obtaining, by a point-of-sale (POS) device from a certification authority, a certificate data item that identifies the POS device for completing a purchase by a consumer, generating, by the POS device comprising a computer processor, a payment request for the payment to complete the purchase, wherein the payment request comprises the certificate data item, broadcasting, by the POS device, the payment request via a wireless signal within a pre-determined range of the POS device, wherein the payment request is received by a mobile device of the consumer via the wireless signal, wherein the mobile device stores payment credential of the consumer, receiving, by the POS device in response to the broadcasting, an encrypted payment credential from the mobile device of the consumer, wherein the encrypted payment credential is generated by the mobile device encrypting the payment credential based on the certificate data item, and decrypting, by the computer processor, the encrypted payment credential based on the certificate data item to retrieve the payment credential for processing the payment.

In general, in one aspect, the invention relates to a system for processing payment. The system includes a point-of-sale (POS) device, a mobile device of a consumer, and a certification authority interfacing with the POS device and configured to providing a certificate data item to the POS device, wherein the certificate data item identifies the POS device for completing a purchase by the consumer, wherein the POS device is configured to (i) obtain the certificate data item from the certification authority, (ii) generate a payment request for the payment to complete the purchase, and wherein the payment request comprises the certificate data item, (iii) broadcast the payment request via a wireless signal within a pre-determined range of the POS device, (iv) receive, in response to broadcasting the request, an encrypted payment credential from the mobile device of the consumer, and (v) decrypt the encrypted payment credential based on the certificate data item to retrieve a payment credential for processing the payment, wherein the mobile device of the consumer is configured to (vi) store the payment credential of the consumer, (vii) receive, from the POS device and via the wireless signal, the payment request for the payment, (viii) generate, in response to the payment request, the encrypted payment credential by encrypting the payment credential based on the certificate data item, and (ix) send the encrypted payment credential to the POS device.

In general, in one aspect, the invention relates to a non-transitory computer readable medium storing instructions for processing payment. The instructions, when executed by a computer processor, comprising functionality for obtaining, by a point-of-sale (POS) device from a certification authority, a certificate data item that identifies the POS device for completing a purchase by a consumer, generating, by the POS device, a payment request for the payment to complete the purchase, wherein the payment request comprises the certificate data item, broadcasting, by the POS device, the payment request via a wireless signal within a pre-determined range of the POS device, wherein the payment request is received by a mobile device of the consumer via the wireless signal, wherein the mobile device stores payment credential of the consumer, receiving, by the POS device and in response to the broadcasting, an encrypted payment credential from the mobile device of the consumer, wherein the encrypted payment credential is generated by the mobile device encrypting the payment credential based on the certificate data item, and decrypting the encrypted payment credential based on the certificate data item to retrieve the payment credential for processing the payment.

Other aspects of the invention will be apparent from the following transaction description and the appended claims.

### BRIEF DESCRIPTION OF DRAWINGS

FIG. 1 shows a block diagram of a system in accordance with one or more embodiments of the invention.

FIG. 2 shows a method flow chart in accordance with one or more embodiments of the invention.

FIGS. 3.1, 3.2, 3.3, 3.4, and 3.5 show an example in accordance with one or more embodiments of the invention.

FIG. 4 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed transaction description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the transaction description.

In general, embodiments of the invention provide a method, system, and computer readable medium for secure proximity exchange of payment credentials and payment receipts between mobile wallets and Point-of-Sale (POS) devices. In one or more embodiments, the secure proximity exchange of payment credentials and payment receipts is performed without external hardware components in addition to the mobile wallet device and POS device. In one or more embodiments, the secure proximity exchange of payment credentials and payment receipts supports cross vendor interoperability.

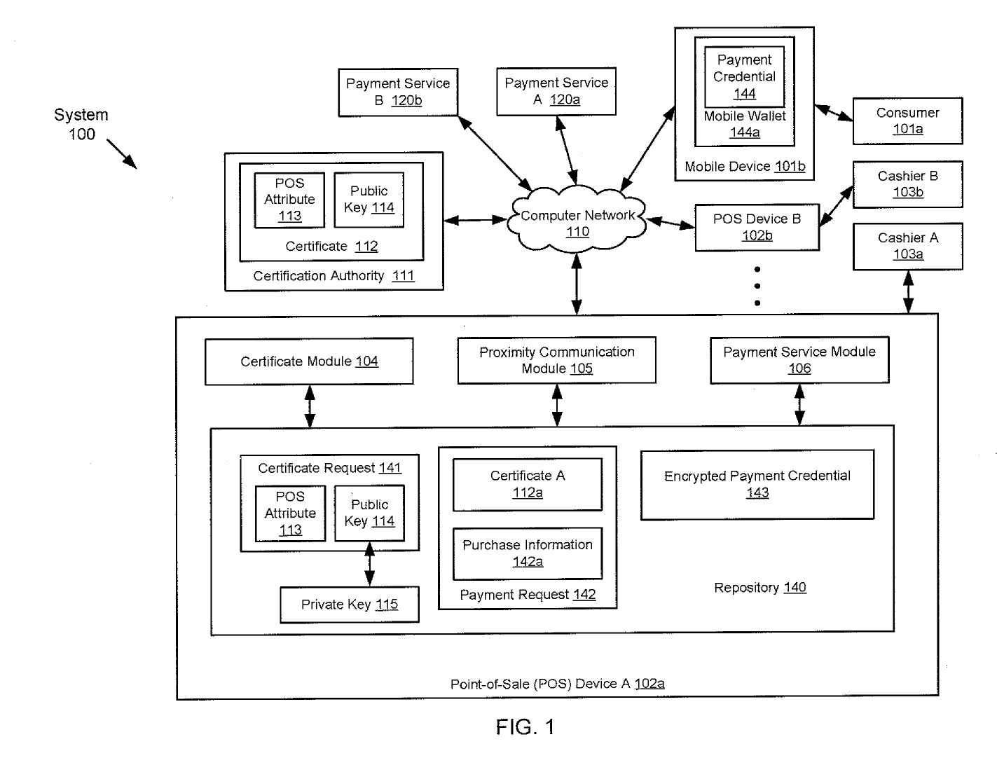

FIG. 1 shows a block diagram of a system (100) in accordance with one or more embodiments of the invention. Specifically, the system (100) includes a consumer (101a) having a mobile device (101b), POS devices (e.g., POS device A (102a) operated by cashier A (103a), POS device B (102b) operated by cashier B (103b)) of one or more merchants (not shown), a payment service A (120a) used by a merchant, a payment service B (120b) used by the consumer (101a), and a certification authority (111) that are coupled via a computer network (110). Further, the POS device A (102a) includes a certificate module (104), a proximity communication module (105), a payment service module (106), and a repository (140) storing data used and/or generated by these various modules. In one or more embodiments of the invention, one or more of the modules and elements shown in FIG. 1 may be omitted, repeated, and/or substituted. Accordingly, embodiments of the invention should not be considered limited to the specific arrangements of modules shown in FIG. 1.

In one or more embodiments of the invention, the computer network (110) may include a BLE proximity communication network, a NFC network, a cellular phone network, a wide area network, a local area network, a public switched telephone network (PSTN), a virtual private network (VPN), and/or any other suitable network that facilitates the exchange of information from one part of the network to another. In one or more embodiments, the computer network (110) is coupled to or overlaps with the Internet.

In one or more embodiments of the invention, the repository (140) may include a disk drive storage device, a semiconductor storage device, a database management system, other suitable computer data storage device, or combinations thereof. In one or more embodiments, content stored in the repository (140) may be a data file, a linked list, a data sequence, a database, a graphical representation, or any other suitable data structure.

In one or more embodiments of the invention, the POS devices (e.g., POS device A (102a), POS device B (102b)) are machines (including hardware and software components) used by one or more merchants (not shown) to complete retail transactions where consumers (e.g., consumer (101a)) make payments to the merchants in exchange for goods or services. For example, a merchant uses the POS device A (102a) to calculate the amount owed by the consumer (101a) and provide options for the consumer (101a) to make payment. In one or more embodiments, the POS devices (e.g., POS device A (102a), POS device B (102b)) may include cash registers, touch screens, scanners, weighing scales, and/or any other wide variety of hardware and software for completing the retail transactions. For example, a grocery or candy store uses a scale at the point of sale, while bars and restaurants use software to customize the item or service sold when a customer has a special meal or drink request.

In one or more embodiments, the POS device A (102a) includes the certificate module (104) that is configured to submit, to the certification authority (111), a certificate request (141) that includes identification information of the POS device A (102a) and a public key (114) to be embedded in a certificate (112) issued by the certification authority (111). In one or more embodiments, the public key (114) and an associated private key (115) are generated by the POS device A (102a) according to a cryptography standard (e.g., PKI X.509). In one or more embodiments, the public key (114) and an associated private key (115) are generated by the payment service A (120a) that in turn provides the public key (114) to the POS device A (102a). The identification information of the POS device A (102a) is referred to as the POS attribute (113) and may include address information (e.g., MAC address, Bluetooth Address) and visual attributes of the POS device A (102a). For example, the visual attributes may include a visual identifier (e.g., business name, logo, checkout lane number in the retail store) of the POS device A (102a) and/or a facial image of the cashier A (103a) who operates the POS device A (102a). In one or more embodiments, the POS device A (102a) captures the facial image when the cashier A (103a) begins his/her shift using the POS device A (102a).

In one or more embodiments of the invention, the certification authority (111) is an entity that issues digital certificates, such as the certificate (112). In particular, the certificate (112) certifies the ownership of the public key (114) by the named subject (i.e., POS device A (102a)) of the certificate (112). Specifically, the certificate (112) is an electronic document that uses a digital signature (not shown) of the certification authority (111) to bind the public key (114) with the POS attribute (113) that identifies the POS device A (102a). In other words, the digital signature (not shown) on the certificate (112) is an attestation by certification authority (111) that the public key (114) and the POS attribute (113) belong together and are owned by the POS device A (102a). In one or more embodiments, the certification authority (111) is a trusted third party that is trusted by the merchant using the POS device A (102a), the consumer (101a), the payment service provider (120a) that serves the merchant, and/or the payment service provider (120b) that serves the consumer (101a). Based on this trust relationship, the public key (114) and the private key (115) are used for encrypting and decrypting secured payment information exchange between the POS device A (102a) and the mobile device (101b).

Returning to the discussion of the POS device A (102a), in response to sending the certificate request (141), the certificate module (104) receives the certificate (112) from the certification authority (111) for storing in the repository (140) as the certificate A (112a). Specifically, the POS device A (102a) combines the certificate A (112a) and purchase information (142a) to generate the payment request (142). In one or more embodiments, the purchase information (142a) is entered into the POS device A (102a) by the cashier A (103a) and includes merchandise information of the retail transaction, such as item names, prices, applicable taxes, total amount due, etc.

In one or more embodiments, the POS device A (102a) includes the proximity communication module (105) that is configured to broadcast the payment request (142) via a proximity communication (e.g., BTLE) wireless signal within a pre-determined range of the POS device A (102a). In response, the proximity communication module (105) receives encrypted payment credential (143) from the mobile device (101b) based on the proximity communication protocol. Additional details of exchanging the payment request (142) and the encrypted payment credential (143) are described below with respect to the mobile device (101b).

In one or more embodiments of the invention, the consumer (101a) is an individual and the mobile device (101b) may be any mobile computing device configured with computing, data storage, and network communication functionalities. For example, the mobile device (101b) may be a smart phone, a tablet computer, a smart watch, a wearable device, etc. In one or more embodiments, the mobile device (101b) includes a mobile wallet (144a), which is a software application installed on the mobile device (101b) to store, organize, or otherwise manage payment information (e.g., payment credential (144)) of the consumer (101a). For example, the payment credential (144) may include account numbers and other credentials (e.g., pass word) of bank accounts, credit cards, debit cards, and/or other financial accounts of the consumer (101a).

In one or more embodiments, the mobile device (101b) is configured to receive, from the POS device (102a) and via the proximity communication (e.g., BLE) wireless signal, the payment request (142) to complete the retail transaction. For example, the payment request (142) may be received during the retail transaction when the consumer (101a) approaches the POS device (102a) in a retail store or other retail environment. In response to receiving the payment request (142), the mobile device (101b) replies to the payment request (142) by returning the encrypted payment credential (143) to the POS device A (102a) using the proximity communication protocol. In one or more embodiments, the mobile device (101b) encrypts the payment credential (144) to generate the encrypted payment credential (143) based on the public key (114) contained in the certificate A (112a).

In one or more embodiments, the mobile device (101b) may receive, at the same time of receiving the broadcasted payment request (142) from the POS device A (102a), an unintended payment request (not shown) broadcasted from a nearby POS, such as the POS device B (102b) adjacent to the POS device A (102a) in the retail store or other retail environment. To clearly identify the payment request (142) from the POS device A (102a), the mobile device (101b) displays the visual attribute of the POS device A (102a) contained in the payment request (142) (more particularly, the certificate A (112a)) to the consumer (101a) to prevent the consumer (101a) from selecting the nearby POS device B (102b) to submit the encrypted payment credential (143).

Further returning to the discussion of the POS device A (102a), in response to receiving the encrypted payment credential (143) from the mobile device (101b), the payment service module (106) processes the payment using the encrypted payment credential (143). In one or more embodiments, the payment service module (106) uses the private key (115) to decrypt the encrypted payment credential (143) and recover the payment credential (144). Accordingly, the payment service module (106) submits the recovered payment credential (144) to the payment service A (120a) to complete the payment processing. In one or more embodiments, the payment service A (120a) may be a credit card merchant service, a debit card processing service, or any suitable financial institution.

In one or more embodiments, the payment service module (106) submits the encrypted payment credential (143) to the payment service A (120a) directly. For example, the public/private key pair may be originally generated by the payment service A (120a). Accordingly, the payment service A (120a) uses the private key (115) to decrypt the encrypted payment credential (143). In one or more embodiments, the payment is jointly processed by the payment service A (120a) serving the merchant and the payment service B (120b) serving the consumer (101a).

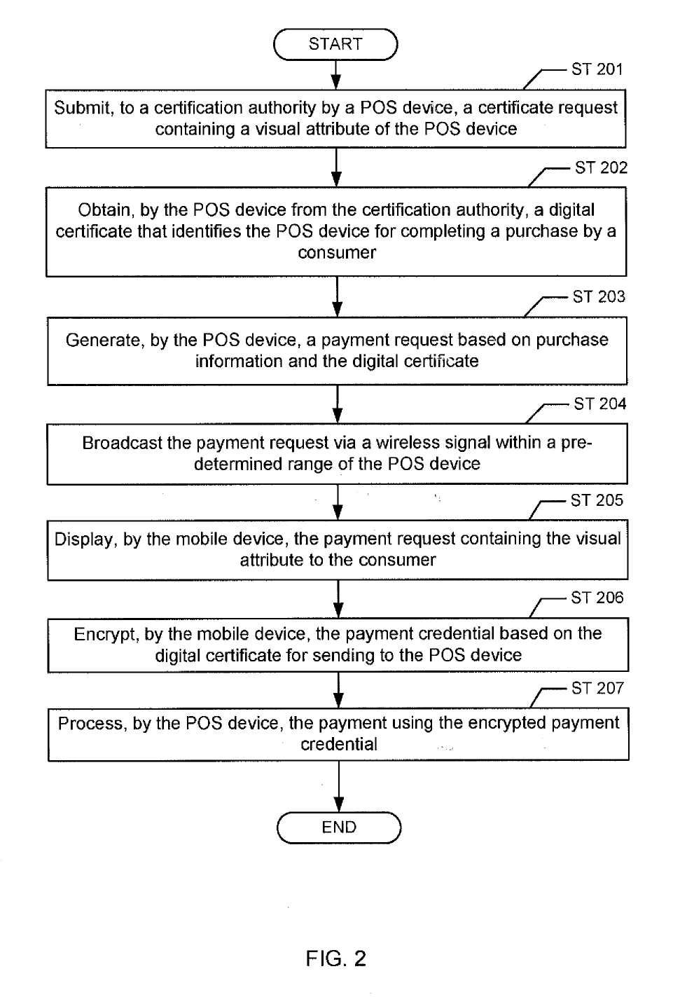

FIG. 2 shows a method flow chart in accordance with one or more embodiments of the invention. In one or more embodiments of the invention, the method of FIG. 2 may be practiced using the system (100) described in reference to FIG. 1 above. In one or more embodiments of the invention, one or more of the steps shown in FIG. 2 may be omitted, repeated, and/or performed in a different order than that shown in FIG. 2. Accordingly, the specific arrangement of steps shown in FIG. 2 should not be construed as limiting the scope of the invention.

Initially in Step 201, a Point-of-Sale (POS) device submits a certificate request to a certification authority to obtain a digital certificate for completing a retail transaction. In one or more embodiments, the certificate request includes a visual attribute of the POS device and a public encryption key that are embedded in the digital certificate by the certification authority. For example, the visual attribute may include a visual identifier of the POS device and/or a facial image of a person operating the POS device.

In Step 202, the POS device obtains the digital certificate from the certification authority. In one or more embodiments, the digital certificate includes the public encryption key, the visual attribute of the POS device, and a digital signature. In particular, the digital signature of the certification authority attests that the visual attribute and the public encryption key contained in the digital certificate truly belong to the POS device. Specifically, the public encryption key and an associated private encryption key are used for encrypting and decrypting secured payment information exchange between the POS device and a mobile device of a consumer. In particular, the mobile device is used by the consumer for making payment to the retail transaction. In one or more embodiments, the mobile device is installed with a mobile wallet application that stores payment credential of the consumer.

In Step 203, the POS device generates a payment request based on purchase information of the retail transaction and the digital certificate. For example, the purchase information includes merchandise name, price, applicable tax, total payment amount, etc. related to the retail transaction. Specifically, the payment request requests the consumer to pay the total payment amount as an exchange for the purchased merchandise.

In Step 204, the POS device broadcasts the payment request via a wireless signal within a pre-determined range of the POS device. In one or more embodiments, the wireless signal is a proximity communication (e.g., BLE) signal.

In Step 205, the mobile device of the consumer receives the payment request via the wireless signal accordingly to the proximity communication protocol. Accordingly, the mobile device displays the payment request to the consumer for acceptance. In one or more embodiments, the displayed payment request includes the visual attribute contained in digital certificate that is attested to belong to the POS device. In particular, the displayed visual attribute is attested to belong to the POS device based on the digital signature of the certification authority. Accordingly, the consumer accepts the payment request upon viewing the displayed visual attribute.

In one or more embodiments, multiple POS devices may be present near the consumer where ranges of the wireless signals from these multiple POS devices may overlap. In such embodiments, the visual attribute of the POS device is displayed to the consumer to distinctly identify the correct POS device from other nearby POS devices that may also be broadcasting their payment requests unrelated to the consumer at the same time. Specifically, the consumer selects the displayed payment request of the correct POS device instead of any unrelated payment request of other nearby POS devices.

In Step 206, in response to the consumer acceptance and/or selection of the payment request, the mobile device encrypts the payment credential based on the digital certificate, e.g., using the public encryption key contained in the digital certificate. In one or more embodiments, the encrypted payment credential is returned to the selected POS device as a reply to the payment request.

In Step 207, the POS device receives the encrypted payment credential to process the payment. In one or more embodiments, the POS device uses the private encryption key to decrypt the encrypted payment credential. In one or more embodiments, the POS device submits the encrypted payment credential to a separate payment service that in turn uses the private encryption key to decrypt the encrypted payment credential and complete the payment processing.

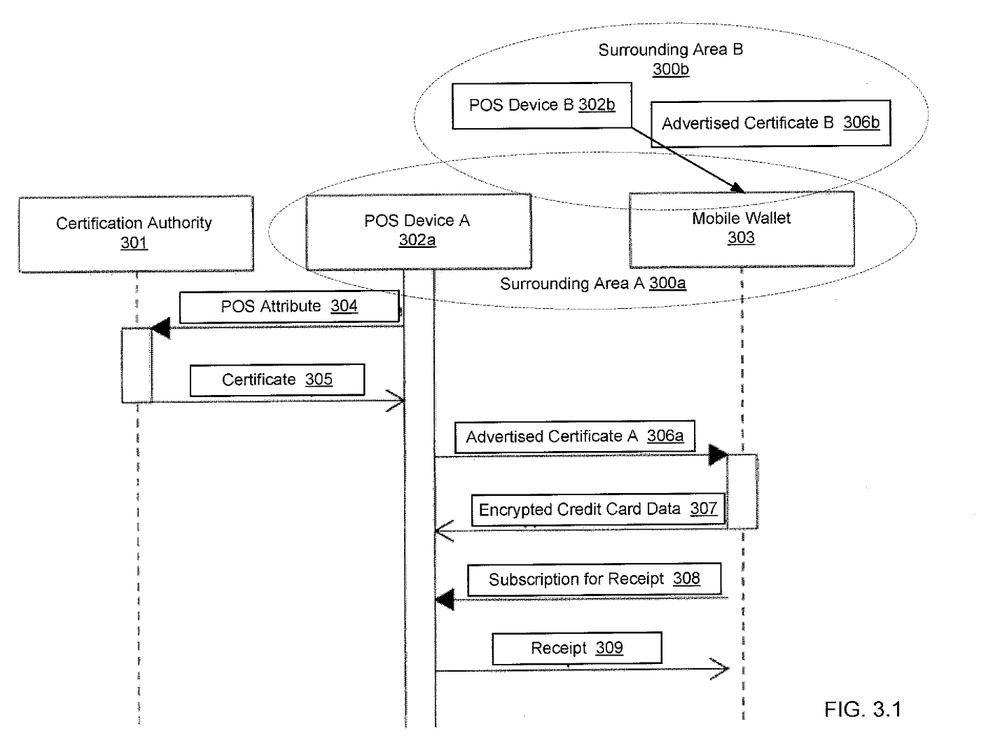

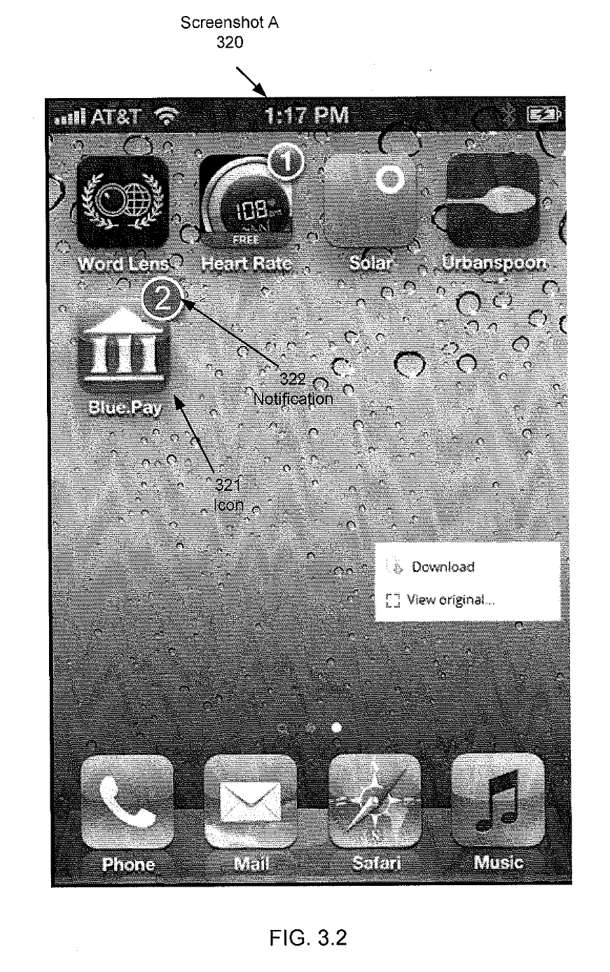

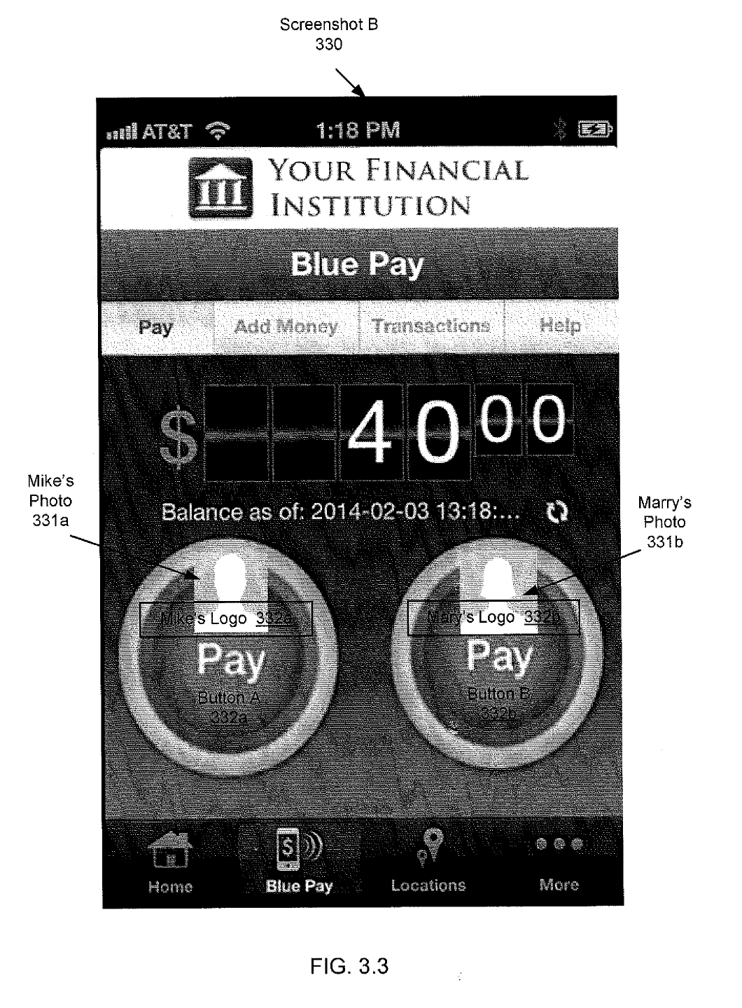

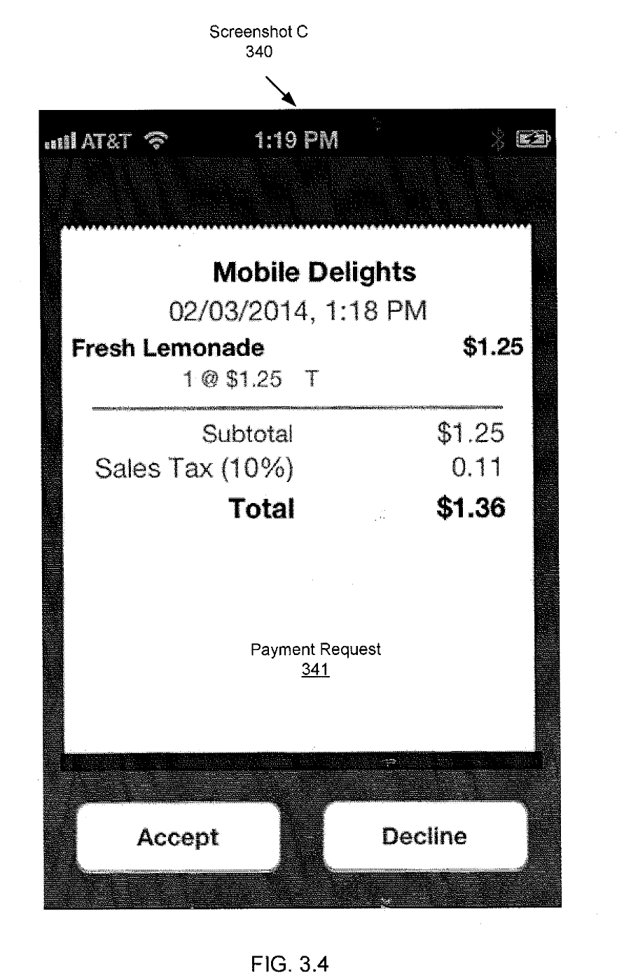

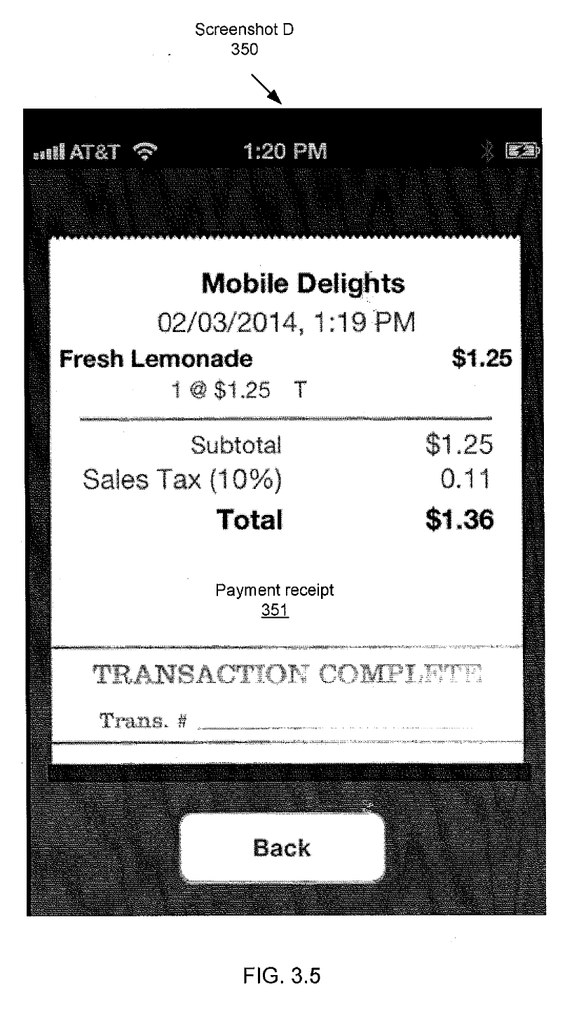

FIGS. 3.1, 3.2, 3.3, 3.4, and 3.5 show an example in accordance with one or more embodiments of the invention. Specifically, FIG. 3.1 shows a schematic diagram of secured credit card data flow at point of sale to complete a purchase. In particular, the secured credit card data flow depicted in FIG. 3.1 is an example to automatically establish a trusted association between a consumer's mobile wallet (303) and the merchant's POS device A (302a) when the consumer carrying the mobile wallet (303) enters a surrounding area A (300a) of the POS device A (302a). Specifically, the surrounding area A (300a) is defined by a range of wireless signal emitted by the POS device A (302a) to establish a proximity wireless network, such as BLE. The trusted association ensures that no secure information is leaked to any other party, and that a technically unsophisticated consumer can easily verify the identity of the POS device A (302a) before transferring credit card information. Generally, the consumer's mobile wallet (303) and the merchant's POS device A (302a) do not have prior association to share any priori knowledge. The example shown in FIG. 3.1 illustrates how to establish this trusted data exchange over wireless network (e.g., BLE network) without shared priori knowledge between the mobile wallet (303) and the POS device A (302a).

As shown in FIG. 3.1, the POS device A (302a) submits a request to a certification authority (301). The request includes a public key and POS attribute (304) of the POS device A (302a), such as a Bluetooth MAC address of the POS device A (302a), a name/logo of the merchant, a checkout lane number of the POS device A (302a), and/or a facial image of a cashier operating the POS device A (302a). Accordingly, the certification authority (301) returns a certificate (305) that attests the public key as assigned/tied to the POS attribute (304). In other words, the certificate (305) ties the public key to the POS attribute (304). For example, a public key/private key pair is generated by the POS device A (302a) where the public key of the key pair is included in the certificate (305).

The cashier then enters the consumer purchase information (i.e., item name, price, etc.) into the POS device A (302a) and selects a payment option (referred to as BluePay service) that is based on proximity communication to receive payment from the consumer.

The POS device A (302a) broadcasts a version of the certificate (305) within the surrounding area A (300a). The broadcasted version of the certificate (305) is referred to as the advertised certificate A (306a). In particular, the advertised certificate A (306a) is a read-only characteristic of the BluePay service over BLE.

Based on the BLE protocol, the mobile wallet (303) scans surrounding Bluetooth Low Energy devices that advertise BluePay service and reads their certificates. In particular, the certificates discovered by the mobile wallet (303) include the advertised certificate A (306a) from the POS device A (302a), among other possible advertised certificates that are also broadcasted from nearby POS devices at the same time. For example, the mobile wallet (303) may also discover the advertised certificate B (306b) from a nearby POS device B (302b) that is adjacent to the POS device A (302a) but operated by a different cashier. In particular, the surrounding area B (300b) defined by the range of BLE wireless signal broadcasted by the POS device (302b) may overlap the surrounding area A (300a).

The mobile wallet (303) verifies that the advertised certificate A (306a) is endorsed (i.e., signed) by the certification authority (301), which is a trusted authority. Since multiple nearby devices advertise BluePay service, the mobile wallet (303) allows the consumer to select the POS device A (302a) based on the checkout lane number of the POS device A (302a) and/or the facial image of the cashier operating the POS device A (302a). For example, the mobile wallet (303) may display the checkout lane number of the POS device A (302a) and/or the facial image of the cashier operating the POS device A (302a) such that the consumer is prevented from accidentally selecting the POS device B (302b) to submit credit card payment information.

Further, in some embodiments the mobile wallet (303) reads a Nonce off another characteristic advertised by the selected BluePay service. The Nonce and the public key embedded in the advertised certificate A (306a) are then used to encrypt consumer's credit card credential stored in the mobile wallet (303). The encrypted credit card credential is referred to as the encrypted credit card data (307) that is submitted by the mobile wallet (303) using a writeable characteristic of the BluePay service over BLTE.

In addition, in some embodiments the mobile wallet (303) subscribes for “receipt ready” notification using the corresponding characteristic of the BluePay service over BLE. Subscription to this characteristic is only opened to the device (i.e., mobile wallet (303)) that submitted the encrypted credit card data (307).

In an example, the POS device A (302a) uses the private key to decrypt the received encrypted credit card data (307) for submitting to a credit card payment service for authorization. In another example, the POS device A (302a) may submit the received encrypted credit card data (307) directly to the credit card payment service, which possesses and uses the private key to decrypt the encrypted credit card data (307).

Once the credit card charge is processed, the POS device A (302a) publishes the receipt through the appropriate characteristic of BLE. Alternatively, the receipt can be transferred using other means, including a writable characteristic on the consumer's device, or using another communication protocol and end-point specified by consumer along with payment card credentials. The receipt may be extended to include loyalty reward points, coupon, and other customer and merchant services.

FIGS. 3.2, 3.3, 3.4, and 3.5 show example smart phone screenshots in a scenario where Mike is a lemonade stand merchant who accepts payments using a tablet computer based POS software that supports a payment protocol “BluePay”. BluePay is an open protocol for mobile payments over proximity wireless network BLE. Carrie is Mike's customer who is using a mobile wallet application on her smart phone that enables her to securely share her credit card credentials (bank account information, virtual currency, or tokens) with any accepting device that supports BluePay. In particular, Carrie uses the mobile wallet to purchase lemonade from Mike in a public park.

Mike rings Carrie's purchase on his tablet computer. Mike's device advertises wirelessly a certificate signed by a known certification authority that associates wireless characteristic of his device (e.g., BLE MAC address) with the legal name of his business “Mobile Delights”, his photo, and a public key associated with his POS application. Specifically, the known certification authority includes a digital signature in the certificate to attest that the business name “Mobile Delights”, Mike's photo, and the public key that are contained in the certificate truly belong to Mike's tablet computer for the purpose of secured exchange of payment information. FIG. 3.2 shows a screenshot A (320) of Carrie's smart phone where the icon (321) and notification (322) indicates to Carrie that two near-by BluePay POS devices expect payments. Upon selecting the icon (321), Carrie sees on her smart phone (i.e., screenshot B (330) shown in FIG. 3.3) that one of the two near-by BluePay POS devices is certified to belong to Mike's lemonade stand and can even see Mike's photo (331a) and Mike's logo (332a) displayed to her as part of the pay button A (332a). In addition, Carrie also sees that the other one of the two near-by BluePay POS devices is certified to belong to Mary's popcorn stand in the park and can even see Mary's photo (331b) and Mary's logo (332b) displayed to her as part of the pay button B (332b).

Apparently, Mary is completing her transaction with her customer purchasing a bag of popcorn. Based on seeing that the photo (331a) matches Mike's face, and Mike's logo (332a) matches a posted signage on Mike's lemonade stand, Carrie clicks the pay button A (332a) to authorize transfer of her credit card credential to initiate the payment to Mike. FIG. 3.4 shows the screenshot C (340) of Carrie's smart phone that displays the payment request (341) for $1.36 of the fresh lemonade to be paid to “Mobile Delights”. Carrie's credit card credential stored in her smart phone is then encrypted using the public key certified to be associated with Mike's POS. Carrie's credit card is charged successfully and a digital payment receipt is sent to her device as a proof of purchase. FIG. 3.5 shows a screenshot D (350) of Carrie's smart phone displaying the payment receipt (351).

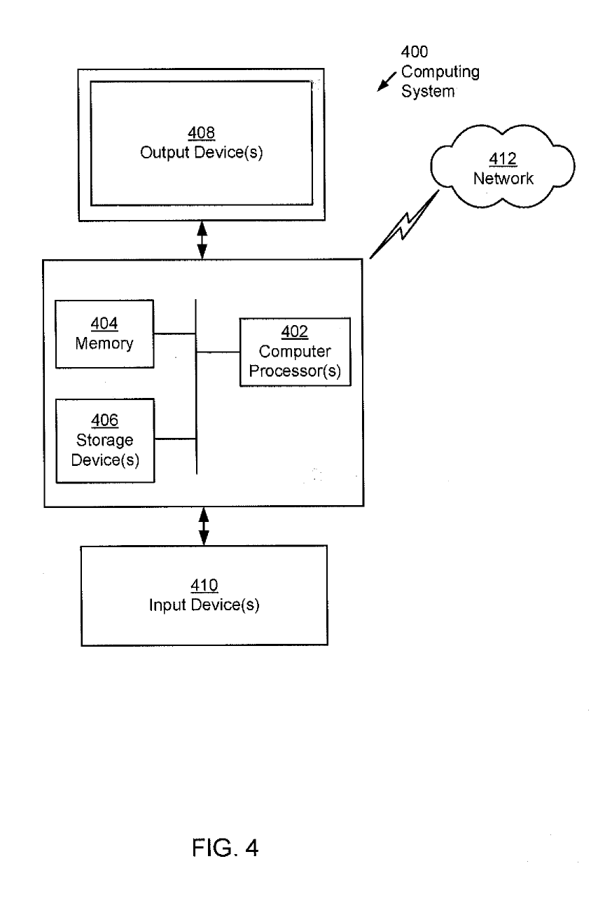

Embodiments of the invention may be implemented on virtually any type of computing system regardless of the platform being used. For example, the computing system may be one or more mobile devices (e.g., laptop computer, smart phone, personal digital assistant, tablet computer, smart watch, a wearable device, or other mobile device), desktop computers, servers, blades in a server chassis, or any other type of computing device or devices that includes at least the minimum processing power, memory, and input and output device(s) to perform one or more embodiments of the invention. For example, as shown in FIG. 4, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device. The computing system (400) may be connected to a network (412) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (400) may be located at a remote location and connected to the other elements over a network (412). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for processing payment, comprising:
submitting, by a point-of-sale (POS) device to a certification authority, a certificate request for a certificate data item that identifies the POS device for completing a purchase by a consumer, wherein the certificate request comprises a visual attribute of the POS device that is embedded in the certificate data item by the certification authority;
obtaining, in response to the certificate request and by the POS device from the certification authority, the certificate data item;
generating, by the POS device, a payment request for the payment to complete the purchase, wherein the payment request comprises the certificate data item;
broadcasting, by the POS device without associating to any specific recipient, the payment request via a wireless signal within a pre-determined range of the POS device, wherein the payment request is received by a mobile device of the consumer via the wireless signal, wherein the mobile device stores payment credential of the consumer, and
wherein the mobile device extracts the visual attribute from the payment request for displaying to the consumer;
receiving, by the POS device in response to the broadcasting, an encrypted payment credential from the mobile device of the consumer, wherein the encrypted payment credential is generated by the mobile device encrypting the payment credential based on the certificate data item, wherein the consumer selects the POS device to submit the encrypted payment credential in response to viewing the visual attribute;
decrypting the encrypted payment credential based on the certificate data item to retrieve the payment credential for processing the payment; and
further broadcasting, contemporaneously with the POS device broadcasting the payment request, an unintended payment request by an adjacent POS device in proximity to the POS device,
wherein the mobile device displays, to the consumer, the visual attribute to prevent the consumer from selecting the adjacent POS to submit the encrypted payment credential.

2. The method of claim 1,
wherein the certificate data item comprises a public encryption key certified by the certification authority,
wherein the mobile device encrypting the payment credential based on the certificate data item is by using the public encryption key, and
wherein decrypting the encrypted payment credential based on the certificate data item is by using a private encryption key associated with the public encryption key.

3. The method of claim 2, wherein processing the payment comprises:
sending, by the POS device, the payment credential to a first payment service servicing a merchant operating the POS device.

4. The method of claim 3, wherein processing the payment further comprises:
sending, by the first payment service, the payment credential to a second payment service servicing the consumer.

5. (canceled)

6. The method of claim 5,
wherein the unintended payment request comprises another certificate data item having another visual attribute embedded by the certification authority, and
wherein the mobile device displays the another visual attribute to the consumer to further prevent the consumer from selecting the adjacent POS to submit the encrypted payment credential.

7. The method of claim 1,
wherein the visual attribute comprises at least one selected from a group consisting of a visual identifier of the POS device and a facial image of a person operating the POS device.

8. A system for processing payment, comprising:
a point-of-sale (POS) device;
an adjacent POS device in proximity to the POS device;
a mobile device of a consumer; and
a certification authority interfacing with the POS device and configured to:
providing a certificate data item to the POS device, wherein the certificate data item identifies the POS device for completing a purchase by the consumer,
wherein the POS device is configured to:
submit, to the certification authority, a certificate request for the certificate data item, wherein the certificate request comprises a visual attribute of the POS device that is embedded in the certificate data item by the certification authority,
obtain, in response to the certificate request and from the certification authority, the certificate data item,
generate a payment request for the payment to complete the purchase, wherein the payment request comprises the certificate data item,
broadcast, without associating to any specific recipient, the payment request via a wireless signal within a pre-determined range of the POS device,
receive, in response to broadcasting the request, an encrypted payment credential from the mobile device of the consumer, and
decrypt the encrypted payment credential based on the certificate data item to retrieve a payment credential for processing the payment,
wherein the adjacent POS device is configured to:
further broadcast, contemporaneously with the POS device broadcasting the payment request, an unintended payment request, and
wherein the mobile device of the consumer is configured to:
store the payment credential of the consumer,
receive, from the POS device and via the wireless signal, the payment request for the payment,
extract, in response to receiving the payment request, the visual attribute from the payment request for displaying to the consumer,
generate, in response to the payment request, the encrypted payment credential by encrypting the payment credential based on the certificate data item, and
send the encrypted payment credential to the POS device,
wherein the consumer selects the POS device to submit the encrypted payment credential in response to viewing the visual attribute,
wherein the mobile device displays, to the consumer, the visual attribute to prevent the consumer from selecting the adjacent POS to submit the encrypted payment credential.

9. The system of claim 8,
wherein the certificate data item comprises a public encryption key certified by the certification authority,
wherein the mobile device encrypting the payment credential based on the certificate data item is by using the public encryption key, and
wherein decrypting the encrypted payment credential based on the certificate data item is by using a private encryption key associated with the public encryption key.

10. The system of claim 9, further comprising:
a first payment service servicing a merchant operating the POS device,
wherein the first payment service is configured to process the payment based on the payment credential.

11. The system of claim 10, further comprising
a second payment service servicing the consumer,
wherein the second payment service is configured to further process the payment based on the payment credential.

12. (canceled)

13. The system of claim 12,
wherein the unintended payment request comprises another certificate data item having another visual attribute embedded by the certification authority, and
wherein the mobile device is further configured to display the another visual attribute to the consumer to further prevent the consumer from selecting the adjacent POS to submit the encrypted payment credential.

14. The system of claim 8,
wherein the visual attribute comprises at least one selected from a group consisting of a visual identifier of the POS device and a facial image of a person operating the POS device.

15. A non-transitory computer readable medium storing instructions for processing payment, the instructions, when executed by a computer processor, comprising functionality for:
submitting, by a point-of-sale (POS) device to a certification authority, a certificate request for a certificate data item that identifies the POS device for completing a purchase by a consumer, wherein the certificate request comprises a visual attribute of the POS device that is embedded in the certificate data item by the certification authority;
obtaining, in response to the certificate request and by the POS device from the certification authority, the certificate data item;
generating, by the POS device, a payment request for the payment to complete the purchase, wherein the payment request comprises the certificate data item;
broadcasting, by the POS device without associating to any specific recipient, the payment request via a wireless signal within a pre-determined range of the POS device, wherein the payment request is received by a mobile device of the consumer via the wireless signal, wherein the mobile device stores payment credential of the consumer,
wherein the mobile device extracts the visual attribute from the payment request for displaying to the consumer;
receiving, by the POS device in response to the broadcasting, an encrypted payment credential from the mobile device of the consumer, wherein the encrypted payment credential is generated by the mobile device encrypting the payment credential based on the certificate data item, wherein the consumer selects the POS device to submit the encrypted payment credential in response to viewing the visual attribute;
decrypting the encrypted payment credential based on the certificate data item to retrieve the payment credential for processing the payment; and
further broadcasting, contemporaneously with the POS device broadcasting the payment request, an unintended payment request by an adjacent POS device in proximity to the POS device,
wherein the mobile device displays, to the consumer, the visual attribute to prevent the consumer from selecting the adjacent POS to submit the encrypted payment credential.

16. The non-transitory computer readable medium of claim 15,
wherein the certificate data item comprises a public encryption key certified by the certification authority,
wherein the mobile device encrypting the payment credential based on the certificate data item is by using the public encryption key, and
wherein decrypting the encrypted payment credential based on the certificate data item is by using a private encryption key associated with the public encryption key.

17. The non-transitory computer readable medium of claim 16, wherein processing the payment comprises:
sending, by the POS device, the payment credential to a first payment service servicing a merchant operating the POS device.

18. The non-transitory computer readable medium of claim 17, wherein processing the payment further comprises:
sending, by the first payment service, the payment credential to a second payment service servicing the consumer.

19. (canceled)

20. The non-transitory computer readable medium of claim 19,
wherein the unintended payment request comprises another certificate data item having another visual attribute embedded by the certification authority, and
wherein the mobile device displays the another visual attribute to the consumer to further prevent the consumer from selecting the adjacent POS to submit the encrypted payment credential.
